(19) United States
(12) Patent Application Publication
(10) Pub. No.: US 2015/0246665 A1
(43) Pub. Date: Sep. 3, 2015

(54) Brake System for a Vehicle

(71) Applicant: BOMBARDIER TRANSPORTATION GMBH, Berlin (DE)

(72) Inventor: Claus-Dieter Postler, Hambuhren (DE)

(21) Appl. No.: 14/439,517

(22) PCT Filed: Oct. 30, 2013
(86) PCT No.: PCT/EP2013/072715

§ 371 Date: Apr. 29, 2015

(30) Foreign Application Priority Data
Oct. 30, 2012 (DE) 10 2012 110 404.2

(51) Int. Cl. B60T 13/44; B61H 11/00; B60T 8/40; B61H 5/00

(52) U.S. Cl. CPC B60T 13/44; B61H 5/00; B61H 11/00; B60T 8/4077

(57) ABSTRACT

A brake system for a vehicle, in particular a rail vehicle, has a braking device, wherein the braking device has a braking apparatus for braking at least one wheel of the vehicle and the braking device has a pneumatic connecting apparatus for connecting to a pneumatic energy supply unit for supplying the braking apparatus with pneumatic braking energy. The braking apparatus is designed as a hydraulic braking apparatus, wherein the braking device has a conversion apparatus connected between the pneumatic connecting apparatus and the braking apparatus for converting the pneumatic braking energy into hydraulic braking energy.

### BACKGROUND OF THE INVENTION

The present invention relates to a braking system for a vehicle, in particular a rail vehicle, with a braking device, wherein the braking device has a braking apparatus for braking at least one wheel of the vehicle and the braking device has a pneumatic connection device for connection to a pneumatic energy supply unit for supplying the braking apparatus with pneumatic braking energy. The present invention further relates to a running gear for a vehicle and a vehicle having a braking system according to the invention. Likewise, it relates to a method for actuating a braking apparatus of a vehicle.

In modern rail vehicles, such as locomotives, multiple traction units, passenger coaches and, increasingly, freight wagons (but also in other vehicles) such pneumatic braking systems are known, in which, usually, disc brake devices (hence, typically, at least one brake disc and brake actuator together with associated brake mechanics) are used. As a rule, a braking control of the vehicle provides a pneumatic brake cylinder pressure, which acts on a brake cylinder, which then transmits the necessary braking power via the brake mechanism and the brake pads to the brake disc. As needed, there are usually provided between one and four such braking systems for one wheel unit (e.g. a wheel set, a wheel pair or even a single wheel).

Such braking systems, due to the pneumatic operating principle, require a relatively large amount of space within the running gear or within the wagon body of the vehicle. Especially in a running gear of a modern railway vehicle (not least due to the ever increasing complexity of such running gears, especially the steady increase in the number of active components of such running gears) this leads to increasing problems in the integration of the braking equipment.

Another problem arises from the frequent requirement for the lowest possible weight of the vehicle, which is not least motivated by the significant savings that can arise for the operator in the operation of the vehicle. Furthermore, the known braking apparatuses include a wear adjustment mechanics, which are built-in to the brake mechanics, which are mostly relatively complicated and malfunction-prone and which are intended to compensate for wear of the friction elements and, thus, to provide an almost equally short stroke of the brake actuator over the life of the friction elements. All this leads to a considerable mass of the braking apparatus. Hence, known braking apparatuses (brake actuator and brake mechanics) of known rail vehicles, depending on the model, usually have a mass of about 65 kg to 120 kg.

### BRIEF DESCRIPTION OF THE INVENTION

The present invention is therefore based on the object to provide a braking system and a method for operating a brake device of the above type, which doesn't have the above-mentioned disadvantages or at least has them to a lesser extent, in particular, which, in a simple way with a compact, space-saving design, allows a reduction of the vehicle mass at reliably guaranteed braking function.

The present invention solves this problem on the basis of a braking system according to the preamble of claim 1 by the features specified in the characterizing part of claim 1. It furthermore achieves this object starting from a method according to the preamble of claim 11 by the features of the characterizing part of claim 11.

The present invention is based on the technical teaching that in a simple manner with a compact, space-saving design, a reduction of the vehicle mass with unalteredly reliable braking function can be achieved, if the braking apparatus is executed as a space-saving and comparatively lightweight hydraulic braking apparatus and the available pneumatic braking energy is converted into hydraulic braking energy, which is then used to operate the braking apparatus. Benefits are achieved by the maximum hydraulic working pressures, which typically are significantly higher than the available maximum pneumatic working pressure but which are easily manageable. Due to the higher working pressure in a hydraulic system, the brake actuator itself can be made much smaller in order to produce the same braking force. Hereby the mass of the system is considerably reduced compared to a purely pneumatic system.

Furthermore, such a hydraulic system allows a much simpler realization of an adjusting device to compensate for wear on the friction elements of the brakes. Hence, for a wear compensating adjustment of the brake mechanism, it is sufficient to simply supply additional hydraulic medium to the hydraulic system. As a result, the brake actuator, already in its rest position (i.e. when the brake is released), is in a state where it is deflected by a certain amount (corresponding to the supplied amount of hydraulic medium). As a result, the already partially worn friction element of the brake mechanism is brought closer again to its counterpart on the wheel unit, such as a disc, so that the working stroke up to the onset of the braking effect can be reduced to the original amount as it exists with the unworn friction elements.

Another great advantage of the invention is that the system can be seamlessly integrated into existing pneumatic brake systems, without their system architecture, especially their security-related areas would have to be modified. Accordingly, the present invention is ideally suited for retrofitting existing vehicles having a pneumatic brake system. Under safety aspects, the hydraulic part of the design according to the invention can, in principle, be regarded simply as a pneumatically driven mechanical component of the braking system. This considerably simplifies the approval process for a braking system designed in such a manner.

According to a first aspect the present invention therefore relates to a braking system for a vehicle, in particular a rail vehicle, with a braking device, wherein the braking device has a braking apparatus for braking at least one wheel of the vehicle and the braking device has a pneumatic connection device for connection to a pneumatic energy supply unit for supplying the braking apparatus with pneumatic braking energy. The braking apparatus is designed as a hydraulic braking apparatus and the braking device has a converting device inserted between the pneumatic connection device and the braking apparatus for converting the pneumatic braking energy into hydraulic braking energy

The conversion of the pneumatic braking energy to hydraulic braking energy can generally be done in any suitable manner. Typically, the converting device comprises a converting unit, wherein the converting unit has a pneumatic input side, which is connectable to the pneumatic connecting device, and the converting unit has a hydraulic output side, which is connectable to the braking apparatus.

The converting device can in principle be designed in any suitable manner. In particular, it may be distributed over several separate components. Preferably, the converting device is arranged in a central housing, in which also further components of the brake system are accommodated. It is particularly advantageous if the converting unit is designed as a compact, separately replaceable component.

Here, for example, completely or partially fluid-dynamically operating devices such as pumps or the like can be used. In particularly simply configured variations of the present invention, however, an at least primarily fluid-static principle for the conversion is selected. Preferably, the converting unit here operates on a displacement principle. For this purpose, with very simply designed variants of the invention, it may comprise at least one piston-cylinder arrangement via which the conversion takes place.

Typically, the converting device is configured to convert an input pressure at the pneumatic input side to an output pressure at the hydraulic output side, wherein the output pressure is higher than the input pressure. Here, the degree of the pressure conversion ratio is selected as a function of the respective application. Preferably, the output pressure is 10 times to 200 times, preferably 15 times to 150 times, more preferably 20 times to 100 times, the input pressure, since it allows for achieving particularly compact braking apparatuses with high power density. Thus, at an inlet pressure of 3 bar to 5 bar, the output pressure can, for example, be 100 bar to 300 bar.

The conversion may simply take place in that the pneumatic braking pressure Pₚₙₑᵤ acts on an input side effective piston area Aₚₙₑᵤ and, hence exerts an an input side force Fₚₙₑᵤ on the piston. The input side force Fₚₙₑᵤ is converted with a force conversion ratio FR into an output side force F_{hydr}(=FR·Fₚₙₑᵤ), which acts at the output side effective area A_{hydr}, which in turn acts on the hydraulic medium, hence, generates the output-side hydraulic braking pressure P_{hydr}. Depending on the ratio of the effective piston areas a corresponding (inverse) ratio of the pressures results, it holds thus:

$$\frac{{P}_{hydr}}{{p}_{pneu}} = FR \cdot \frac{{A}_{pneu}}{{A}_{hydr}} . \qquad ( 1 )$$

In particularly preferred, since simply designed variants, the force conversion ratio FR=1, i.e. the two piston surfaces are, for example, rigidly coupled to each other without an additional mechanism for force transmission.

In certain variants of the invention the converting device comprises an input side piston-cylinder arrangement with an input side effective piston area and a mechanically coupled output side piston-cylinder arrangement with an output side effective piston area, wherein, in particular, the input side effective piston area is 10 times to 200 times, preferably 15 times to 150 times, more preferably 20 times to 100 times, the output side effective piston area.

As already mentioned above, in preferred variants of the invention, an adjusting device is provided which is configured to reduce an increased working stroke of at least one braking element of the braking apparatus as it results, for example, from wear of the friction elements.

For actuating the adjusting device, a separate actuator may be provided which, if appropriate, is to be operated manually or is to be controlled separately. Here, a separate power supply may be provided for the adjusting device. Preferably, the adjustment takes place automatically when reaching a certain degree of wear. Reaching this degree of wear can be detected in any suitable manner. Hence, arbitrary sensors can be used to detect that this state is reached.

In particularly simply configured variations of the braking system of the invention, the adjusting device is actuated by the converting device. This has the advantage that a solution can be realized, in which the operation of the adjustment only ensues if the converting device in operation must be run at an increased working stroke due to wear. Thus, the actuation of the adjustment device is effected only when this is necessary and without requiring a separate sensor system and/or a separate energy supply.

The point in time or the state, respectively, at which an actuation of the adjusting device is carried out by the converting device can, in principle, be chosen arbitrarily according to the specifications for the respective vehicle. Preferably, the converting device has a maximum working stroke and the actuation of the adjusting device only ensues when the working stroke of the converting device has reached 60% to 90%, preferably 65% to 85%, more preferably 70% to 80%, of the maximum stroke, as particularly advantageous configurations are achieved herewith.

The adjustment device can, in principle, be designed in any suitable manner. In particularly simply configured variations of the invention, also the adjusting device comprises a piston-cylinder arrangement for supplying additional hydraulic medium, which is then operated, for example, via a tappet device of the converting device.

Furthermore, the adjustment device may be designed as a separate module, which is arranged separately from the converting device. However, particularly advantageous since compact designs are characterized by the fact, that the adjusting device is arranged in a common housing together with the converting device. Herein, it is particularly advantageous, if the adjusting device is configured to be separately replaceable.

Preferably, the adjustment device is configured to supply additional hydraulic medium to a working chamber of the braking apparatus to reduce the working stroke of the at least one brake element (from its rest position until the onset of the braking effect). Here, the adjusting device is preferably configured to supply, in a first step, in particular during actuation of the braking apparatus, additional hydraulic medium to an intermediate storage, and to supply, in a second step following the first step, in particular during a release of the braking apparatus, additional hydraulic medium from the intermediate storage to the working chamber.

In this way it is possible, during the braking operation, wherein, naturally, an elevated pressure prevails in the working chamber of the braking apparatus, there is initially only supply on a lower pressure level to the intermediate storage (in this case hydraulically decoupled from the working chamber) and to have supply from the intermediate storage to the working chamber only when the pressure in the working chamber of the braking apparatus has dropped back to an appropriately low level. The selective coupling of the intermediate storage to the working space can be easily realized by appropriate biased check valves or the like.

In principle, a separate power supply may be provided for the supply from the intermediate storage into the working chamber. However, this supply is preferably carried out without any additional power supply. For this purpose, the intermediate storage is preferably designed as a spring-loaded storage, which in the second step autonomously supplies additional hydraulic medium to the working chamber.

In further preferred variants of the brake system of the invention a slide protection device is provided. The slide protection device is preferably configured in a conventional manner to interrupt, under the control of a control device, a braking operation of the braking apparatus to prevent slippage of the rail wheels on the rail and the consequent reduction of the force transmission between wheel and rail.

The slide protection device is preferably inserted between the pneumatic connection device and the converting device, so that its function can be realized in a conventional manner at a central location via pneumatic components, such as one or more corresponding solenoid valves or the like. Preferably, the slide protection device therefore comprises at least one venting valve controlled by the control device. Again, it is in turn advantageous if the slide protection device is arranged as a (preferably separately replaceable) component in a common housing together with the converting device in order to achieve a particularly compact design.

Additionally or alternatively, a pneumatic pressure sensor is preferably provided which is configured to deliver a signal representative of a pneumatic braking pressure to a control device in order to monitor the pneumatic braking pressure and/or to regulate, if necessary.

The pneumatic pressure sensor is preferably inserted between the pneumatic connection device and the converting device, wherein (in case of the presence of a slide protection device) it is preferably inserted between the slide protection device and the converting device in order to be able to also monitor the effectiveness of the slide protection device or to regulate the later, respectively.

Again, it is in turn advantageous if the pressure sensor is a (preferably separately replaceable) component arranged in a common housing with the converting device in order to achieve a particularly compact design.

As stated above, both the converting device and the adjusting device can be designed as a piston-cylinder assembly. In preferred variants of the invention, at least one piston-cylinder assembly is provided, which defines a working chamber, wherein, on the side of the piston facing away from the working chamber, a gas volume is defined, which, preferably, is sealed from the environment. In this case, the gas volume is connected to a respiration volume in such a way that a power loss created during use of the piston-cylinder arrangement due to the change of the gas volume is less than 2%, preferably less than 1%, more preferably less than 0.5%, whereby a particularly low-loss design can be realized.

The size of the respiration volume can, in principle, be tuned to the respective application, particularly to the power consumption. Preferably, the respiration volume is 2 l to 25 l, preferably 5 l to 20 l, more preferably 10 l to 15 l;

Here again, it is advantageous if the respiration volume (optionally also as separately replaceable component) is arranged in a common housing with the converting device to achieve a particularly compact design.

In further preferred variants of the braking system according to the invention the converting device comprises an emergency brake unit, which is connectable to a pneumatic emergency brake connection. The emergency brake unit can be biased via the emergency brake connection with a pneumatic bias in such a manner that the emergency brake unit is actuated by the converting device upon a decrease of the pneumatic bias below a predeterminable value for initiating a braking.

In principle, the emergency brake can, again, be designed in any suitable manner. Preferably, the emergency brake unit comprises a piston-cylinder assembly, which is biased by an, in particular mechanical, spring in order to apply the force for the braking operation in case of a pressure drop at the pneumatic emergency brake connection.

The present invention further relates to a running gear for a vehicle, in particular a rail vehicle, with at least one wheel unit, in particular a wheel set, and a braking system according to the invention, wherein the braking system is configured for braking the at least one wheel unit, but in particular all the wheel units, of the running gear. Herewith, the variants and benefits described above in connection with the braking system according to the invention can be realized to the same extent, so only reference to the above statements is made here.

The present invention further relates to a vehicle, in particular a rail vehicle, comprising at least a running gear with at least one wheel unit, in particular a wheel set, a wagon body supported on the at least one running gear, and a braking system according to the invention, which is configured for braking the at least one wheel unit, but in particular all wheel units, of the running gear. Herewith too, the variants and benefits described above in connection with the braking system according to the invention can be realized to the same extent, so only reference to the above statements is made here.

It is understood that also with such a vehicle the braking system can be fully integrated into the running gear. In certain variants creating very little strain on the building space budget of the running gear, however, the converting device is arranged at the wagon body, preferably in the region of the at least one running gear.

The present invention further relates to a method for actuating a braking device of a vehicle, in particular a rail vehicle, in which the braking device is supplied via a pneumatic energy supply unit with pneumatic brake energy for braking at least one wheel of the vehicle. Herein, via a converting device inserted between the pneumatic energy supply unit and a braking apparatus of the braking device, the pneumatic braking energy is converted into hydraulic braking energy and the braking device is hydraulically operated. Herewith too, the variants and benefits described above in connection with the braking system according to the invention can be realized to the same extent, so only reference to the above statements is made here.

Suffice it to say that the converting device converts an input pressure at a pneumatic input side to an output pressure at a hydraulic output side, wherein the output pressure is preferably greater than the input pressure. In particular, the output pressure is preferably 10 times to 200 times, preferably 15 times to 150 times, more preferably 20 times to 100 times, the input pressure.

Furthermore, also in this case, preferably, an, in particular wear related, increased working stroke of at least one braking element of the braking apparatus is reduced via an adjusting device, wherein the adjusting device is preferably actuated by the converting device. Here as well, the converting device preferably has a maximum working stroke and the actuation of the adjustment device only ensues when the working stroke of the converting device has reached 60% to 90%, preferably 65% to 85%, more preferably 70% to 80%, of the maximum working stroke.

Preferably, the adjusting device supplies additional hydraulic fluid to a working chamber of the braking apparatus to reduce the working stroke of the at least one braking element, wherein the adjusting device preferably supplies, in a first step, in particular during actuation of the braking apparatus, additional hydraulic medium to an intermediate storage, and supplies, in a second step following the first step, in particular during a release of the braking apparatus, additional hydraulic medium from the intermediate storage to the working chamber. Here as well, the intermediate storage preferably autonomously (i.e. without active energy supply) supplies the additional hydraulic medium to the working chamber.

Finally, preferably, an emergency brake unit of the converting device is biased with a pneumatic bias in such a manner that the emergency brake unit actuates the converting device upon a decrease of the pneumatic bias below a predeterminable value for initiating a braking operation.

Further preferred embodiments of the invention will become apparent from the dependent claims and the following description of preferred embodiments which makes reference to the accompanying drawings. It is shown in:

### BRIEF DESCRIPTION OF DRAWINGS

FIG. 1 a schematic side view of a part of a preferred embodiment of the vehicle according to the invention with a preferred embodiment of the running gear according to the invention, comprising a preferred embodiment of the braking system of the invention;

FIG. 2 a schematic side view of a braking apparatus of the vehicle of FIG. 1;

FIG. 3 a schematic sectional view of the braking apparatus of FIG. 2 along line III-Ill of FIG. 2;

FIG. 4 a schematic diagram of a part of the braking system of the vehicle of FIG. 1;

FIG. 5 a schematic side view of a braking apparatus of a further preferred embodiment of the braking system according to the invention;

FIG. 6 a schematic sectional view of the braking apparatus of FIG. 5 along line VI-VI of FIG. 5.

### DETAILED DESCRIPTION OF THE INVENTION

### First Embodiment

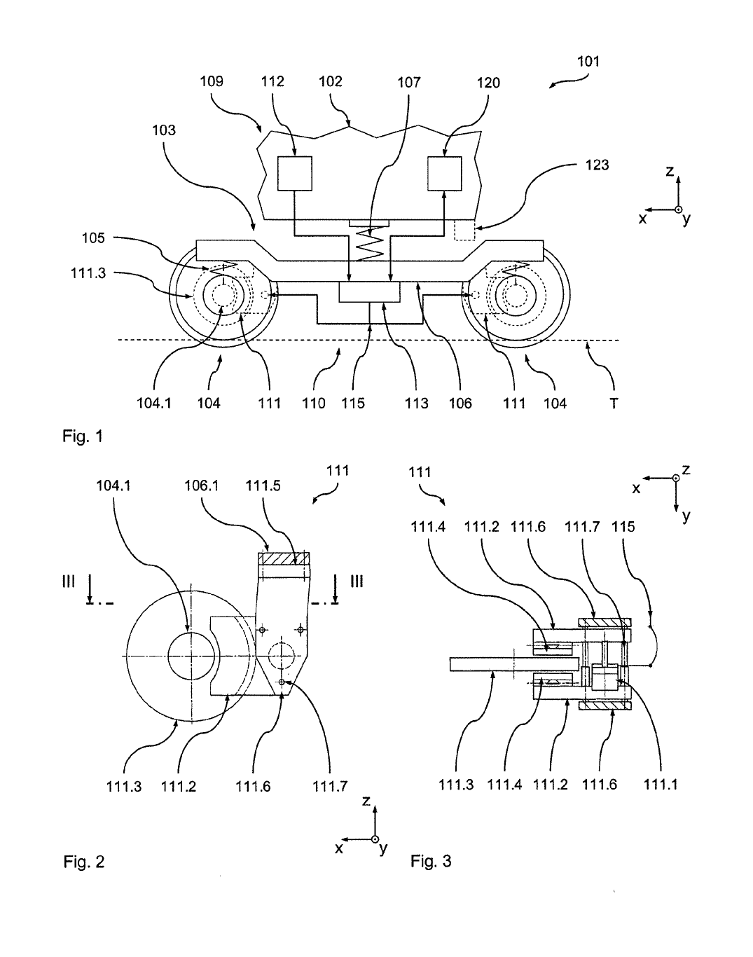

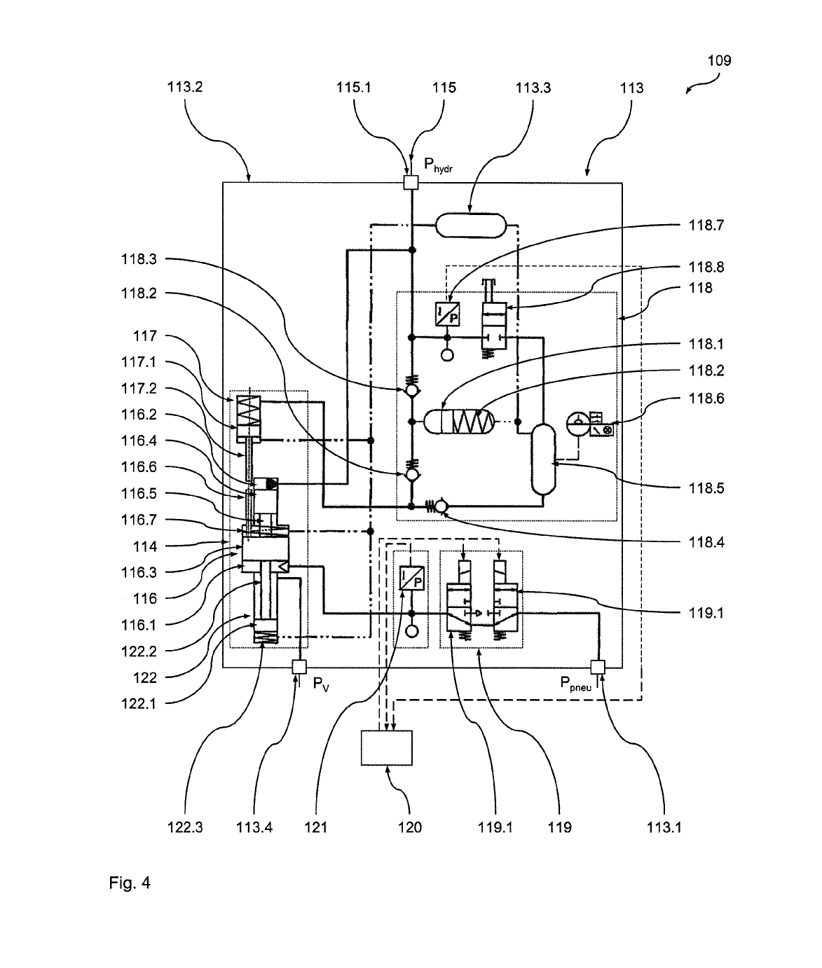

In the following, with reference to FIGS. 1 to 4 a first preferred embodiment of the vehicle according to the invention in the form of a rail vehicle 101 will be described.

The vehicle 101 comprises a wagon body 102 which is supported in the region of its two ends respectively on a running gear in the form of a bogie 103. It is understood, however, that the present invention can also be used in conjunction with other configurations in which the wagon body is supported only on one running gear.

For easier understanding of the following explanations, a vehicle coordinate system x, y, z (defined by the wheel contact plane of the bogie 103 on the rails T) is introduced in the figures, wherein the x-coordinate designates the longitudinal direction of the rail vehicle 101, the y-coordinate designates the transverse direction of the rail vehicle 101, and the z-coordinate designates the height direction of the rail vehicle 101, respectively.

The bogie 103 comprises two wheel units in the form of wheel sets 104, on each of which a bogie frame 106 is supported via a primary suspension 105. The body 102 is in turn supported via a secondary suspension 107 on the bogie frame 106. The primary suspension 104 and secondary suspension 107 are represented for simplicity in FIG. 1 by helical springs. It is understood, however, that the primary suspension 105 and secondary suspension 107 may be an arbitrarily shaped device, which may include other components in addition to coil springs.

As can be seen from FIG. 1, the vehicle 101 has a brake system 109, via which the wheels of the wheel sets 104 of the bogie 103 can be braked by a braking apparatus 110, which comprises one or more braking apparatuses 111 for each wheel set 104.

For this purpose, the brake system 109 comprises a pneumatic energy supply unit 112, which is arranged in the region of the wagon body 102 and which supplies the brake device 110 with compressed air having a pneumatic braking pressure Pₚₙₑᵤ. Hence, the energy supply unit 112 supplies the braking device 110 with pneumatic braking energy.

The braking apparatus 110 comprises a central control module 113, which is detachably connected to the energy supply unit 112 via a pneumatic connection device 113.1 (for example, a simple tube coupling or the like). The control module 113 comprises a converting device 114 inserted between the pneumatic connection device 113.1 and the braking apparatus 111, which converts the pneumatic braking energy having the pneumatic braking pressure Pₚₙₑᵤ into hydraulic braking energy having a hydraulic braking pressure P_{hydr}, which is then provided via a corresponding hydraulic line system 115 to the hydraulic brake device 111, which is connected via a hydraulic connection device 115.1.

By this conversion of the pneumatic braking energy into hydraulic braking energy it is possible to realize a particularly compact, space-saving design, and thus achieve a reduction in the mass of the vehicle 101 at unchanged reliable braking performance. This is to a large extent due to the fact that some components of the hydraulic brake device 111, in particular, the brake actuator 111.1, due to the significantly higher (compared to the available maximum pneumatic working pressure or braking pressure Pₚₙₑᵤ, respectively) but easily manageable hydraulic working pressure or braking pressure P_{hydr}, respectively, may be designed to be much smaller and therefore lighter in order to generate the same braking force or braking power. By this (compared to a pneumatic braking apparatus of the same power) lower power to weight ratio of the hydraulic brake device 111 the mass of the system is considerably reduced in comparison to a purely pneumatic system.

To convert the pneumatic braking energy into hydraulic braking energy the converting device 114 includes a converting unit 116 having a pneumatic input side in the form of an input side working chamber 116.1 and a hydraulic output side in the form of an output side working chamber 116.2. The pneumatic input side 116.1 is connected to the pneumatic connection device 113.1, while the hydraulic output side 116.2 is connected via the hydraulic line system 115 with the respective braking apparatus 111. The converting device 114 is designed as a compact, separately replaceable module in the form of a pressure module, which is disposed in a central housing 113.2 of the control module 113.

In the present example, the converting unit 116 operates according to a displacement principle. For this purpose, it is designed as a simple piston-cylinder arrangement having an input side piston 116.3 with an input side effective area Aₚₙₑᵤ and an output side piston 116.4 having an output side effective area A_{hydr}. In this example, the input side piston 116.3 and the output side piston 116.4 are rigidly coupled via a piston rod 116.5.

It is understood that, in other variants of the invention, any other type of force transmission between the two pistons 116.3 and 116.4 can be chosen. Thus, for example, a hydraulic coupling may be provided. Furthermore, a transmission or a gearing, respectively, can be integrated into the connection of the two pistons in order to already achieve a force transmission ratio.

The conversion of the braking energy is carried out in the present example in that the pneumatic braking pressure Pₚₙₑᵤ in the input side working chamber 116.1 is acting on the piston area Aₚₙₑᵤ of the input side piston 116.3 and so exerts on the piston an input side force Fₚₙₑᵤ. Due to the rigid coupling via the piston rod 116.5 with a force transmission ratio FR=1, the input side force Fₚₙₑᵤ is converted to an output side force F_{hydr}=Fₚₙₑᵤ, which acts in the output side working chamber 116.2 at the piston surface A_{hydr} of the output piston 116.4 on a hydraulic medium and, hence, produces the output side hydraulic braking pressure P_{hydr} in the hydraulic medium. In the present example, consequently, it holds according to Equation (1):

$$\frac{{P}_{hydr}}{{p}_{pneu}} = \frac{{A}_{pneu}}{{A}_{hydr}} .$$

In the present example, the input side effective piston area Aₚₙₑᵤ is 60 times the effective output side piston area A_{hydr}. Hence, at the hydraulic output side 116.2, a output pressure or hydraulic braking pressure P_{hydr} results, which is 60 times the input pressure or pneumatic braking pressure Pₚₙₑᵤ, whereby a particularly compact braking apparatus 111 with high power density can be realized.

In the present example, the converting unit 116 is designed such that it supplies enough hydraulic medium to the connected braking apparatuses 111 during braking, wherein corresponding safety margins are provided.

The converting device or pressure module 114 further comprises an adjusting device 117, which is configured to reduce an increased stroke of the brake elements or calipers 111.2 of the braking apparatus 111 back to a desired level. Such an increased stroke of the brake elements 111.2 typically results from wear of the friction elements 111.3, which during operation cooperate with the disc 111.4 sitting in a rotationally fixed manner on the axle 104.1 of each wheelset 104.

In the present example, this adjustment is effected in that, via a readjusting piston-cylinder arrangement 117.1 of the adjusting device 117, additional hydraulic medium is supplied into the hydraulic working chamber of the braking apparatus 111 (which, inter alia, comprises the hydraulic line system 115).

Via this additional amount of hydraulic medium in the hydraulic working space of the braking apparatus 111, the brake actuator 111.1 is already in its rest position (i.e., when the brake is released) in a state, in which it is deflected compared to the new state (with unworn friction elements 111.4) by an amount corresponding to the supplied amount of hydraulic medium. As a result, the already partially worn friction elements 111.4 are brought closer again to the brake disc 111.3, such that the working stroke up to the onset of the braking effect can be reduced again to an amount which is at least approximated to the new state.

In the present example, the adjusting device 117 is actuated by the converting unit 116. To this end, the converting unit 116 comprises tappet device 116.5, which is connected to the input side piston 116.3 and which is associated to a piston rod 117.2 of the adjusting piston 117 in such a manner, that it deflects the adjusting piston 117.1 starting with a predetermined working stroke of the converting unit 116. It will be appreciated that, in other variants of the invention, the tappet device may also be arranged in any other place of the converting unit 116.

In this way, a solution is implemented in an advantageous manner in which the operation of the adjustment device 117 does not occur until the converting device 114 and the converting unit 116, respectively, in operation has to execute an increased stroke due to wear. Thus, the actuation of the adjustment device 117 therefore only takes place when this is necessary and without requiring a separate sensor system or a separate energy supply.

In the present example, the piston 117.1 of the adjustment device 117, in a first step, during an operation of the braking apparatus 111, pumps additional hydraulic medium in an intermediate storage 118.1 of a hydraulic module 118. The intermediate storage 118.1 is biased by a spring 118.2 so that, in a second step following the first step, during a release of the braking apparatus 111, additional hydraulic medium is automatically supplied from the intermediate storage into the hydraulic working chamber.

During the first step a first check valve 118.2 prevents backflow of the delivered hydraulic medium in the direction of the adjustment device 117, while a second check valve 118.3 cuts off the intermediate storage 118.1 from the high hydraulic braking pressure P_{hydr} in the working chamber, such that the supply of the additional hydraulic medium into the intermediate storage can ensue under comparatively moderate supply pressure P_{f}<P_{hydr}.

With the end of the braking process, i.e. usually the venting of the pneumatic part of the braking system 109, in the second step, the pistons 116.3 and 116.4 of the converting unit 116 return back to their original position due to the restoring force of a return spring 116.7. The same applies to the readjusting piston 117.1, which is reset to its original position by the restoring force of a return spring 117.3.

Herewith also the hydraulic braking pressure P_{hydr} is lowered to 0 bar. Since hydraulic medium stored in the intermediate storage 118.1 (due to the force of the spring 118.2) now has a higher pressure P_{Z}>P_{hydr}, the hydraulic medium is pumped via the second check valve 118.3 into the hydraulic working chamber and thus also into the brake actuator 111.1. Hereby the brake actuator 111.1 does no longer return to its end position, that it has when it is new, but remains slightly further extended than before the start of the braking process.

Simultaneously with the retraction of the adjusting piston 117.1 a third check valve 118.4 is opened, through which hydraulic medium is sucked from a reservoir 118.5 of the hydraulic module 118. This volume sucked from the reservoir 118.5 is then used as an additional volume for the wear adjustment function.

The time or state, in which an actuation of the adjusting device 117 is performed by the converting unit 116, is selected according to the specifications for the vehicle 101. In the present example, the actuation of the adjusting device 117 is carried out only when the working stroke of the converting device 116 has reached about 75% of the maximum working stroke of the converting unit 116.

The hydraulic module 118 further comprises an optical and possibly also an electrical filling level monitoring device 118.6 as well as a hydraulic pressure sensor 118.7, which is connected to the control device 120 and through which the hydraulic braking pressure P_{hydr} can be monitored.

Furthermore, the hydraulic module comprises a manual release valve 118.8, which is designed such that it can be used both for changing the friction elements 111.4 as well as for an emergency release of the spring reservoir brake (as will be explained in more detail below). Optionally, of course, an electromagnetic remote actuation of the release valve 118.8 (for example, by the controller 120) or a manual remote actuation of the release valve 118.8 (for example, by a cable for the right and left vehicle side) can be realized.

The brake system 109 further comprises an slide protection device 119, which is formed in a conventional manner to interrupt a braking operation of the brake device 111 under the control of a control device 120, to prevent sliding of the wheels of the wheel sets 104 on the track T and the resulting reduction in the transmission of forces between wheel and rail.

In the present example, the slide protection device 119 is inserted between the pneumatic connection device 113.1 and the converting device 114 such that its function is implemented in a conventional manner via pneumatic components at a central location. For this purpose, the slide protection device 119, in the present example, includes two solenoid valves 119.1, which are operated by the control device 120 and which are each designed as a venting valve.

In addition, in the present example, a pneumatic pressure sensor 121 is provided, which provides a signal representative of the applied pneumatic braking pressure Pₚₙₑᵤ to the control device 120 to monitor the pneumatic braking pressure Pₚₙₑᵤ and to optionally regulate the latter via the controller 120. The pneumatic pressure sensor 121 is inserted between the slide protection device 119 and the converting device 114, such that the effectiveness of the slide protection device 119 can also be monitored in the control device 120.

Both the slide protection device 119 and the pressure sensor 121 are arranged in the housing 113.2 as separately replaceable components in order to achieve a particularly compact design.

The piston-cylinder assemblies of the converting unit 116 and of the adjusting device 117, on the side facing away from the respective working chamber of the respective piston 116.3, 116.4 or 117.1, each define gas volumes, each of which is sealed from the environment. These gas volumes do not have any breathing openings to the outside atmosphere, but are connected to a respiration volume 113.3, which is built-in into the housing 113.2 and which is designed such that, the power loss generated during operation of the respective piston-cylinder assembly as a result of the change (specifically, compression) of the respective gas volume is less than 0.5%, by which a particularly low-loss design can be realized. For this purpose, the size of the respiration volume 113.3 is tuned to the brake system 109, in particular its power consumption. In the present case, the respiration volume is 10 I.

The converting device 114, in the present example further comprises an emergency brake unit 122, which is connected to a pneumatic emergency brake connection 113.4 of the control module 113. The emergency brake unit 122 can be biased via the emergency brake connection 113.4 by means of a bias pressure P_{V} with a pneumatic bias in such a manner that, when the bias pressure P_{V} and thus the pneumatic bias falls below a predeterminable value, the emergency brake unit actuates converting unit 116 in order to trigger a braking operation, the above-mentioned spring reservoir brake.

The emergency brake system 122 in turn comprises a piston-cylinder arrangement with a emergency brake piston 122.1, which is rigidly connected via a piston rod 122.2 to the input side piston 116.3 of the converting unit 116. The emergency brake piston 122.1 is biased by a mechanical emergency brake spring 122.3 in order to apply the force for the braking process upon a pressure drop at the pneumatic emergency brake connection 113.4.

In the present example, the housing 113.2 of the control module 113 is configured as a single- or multi-piece cast component. Alternatively, it can be made from a solid piece as a drilled and/or milled component. It includes all the receptacles for the individually replaceable subassemblies 114, 118, 119 and 121 as well as the respiration volume 113.3 built-in to the cast body. Furthermore, the housing 113.2 in the present example includes all internal pneumatic and hydraulic connections, pneumatic and hydraulic connecting devices 113.1, 113.4 and 115.1 to the connected components as well as one or more corresponding electrical interfaces, in particular for the connection to the control device 120.

All pneumatic or hydraulic or electrical connections of the sub-assemblies 114, 118, 119 and 121 to the housing 113.2 of the control module 113 are made with the Insertion and fastening of the respective sub-assembly 114, 118, 119 and 121 of the complete hydraulic block (A) into the control module (A) in a secure and, as needed, leak-free manner.

As can be seen from FIGS. 2 and 3, in the present example, the braking apparatus 111 is a so-called floating caliper brake, which is designed as a compact unit and which is directly connected to an interface flange 106.1 of the bogie frame 106. A cardanic play compensation may be provided between the interface flange 106.1 and an adaptor device 111.5.

The adaptor device carries two guide rod holders 111.6, in which guide rods 111.7 are fixed, which lead the calipers 111.2 with the friction elements 111.4 in the manner of a parallel guide. The hydraulic brake actuator 111.1 connects both calipers 111.2 and, via their friction elements 111.4, generates the braking force acting on the brake disc 111.3.

In the present example, all braking apparatuses 111 of the bogie 103 are supplied with hydraulic braking energy by the central control unit 113. It is understood, however, that in other variants of the invention, for each individual wheel set 104, a separate control unit 113 can be provided.

Furthermore, in the present example, the control unit 113 is arranged in the area of the bogie 103. It is understood, however, that, in other variants of the invention, it may also be provided that the control unit is disposed on or in the wagon body 102 as is indicated in FIG. 1 by the dashed contour 123.

### Second Embodiment

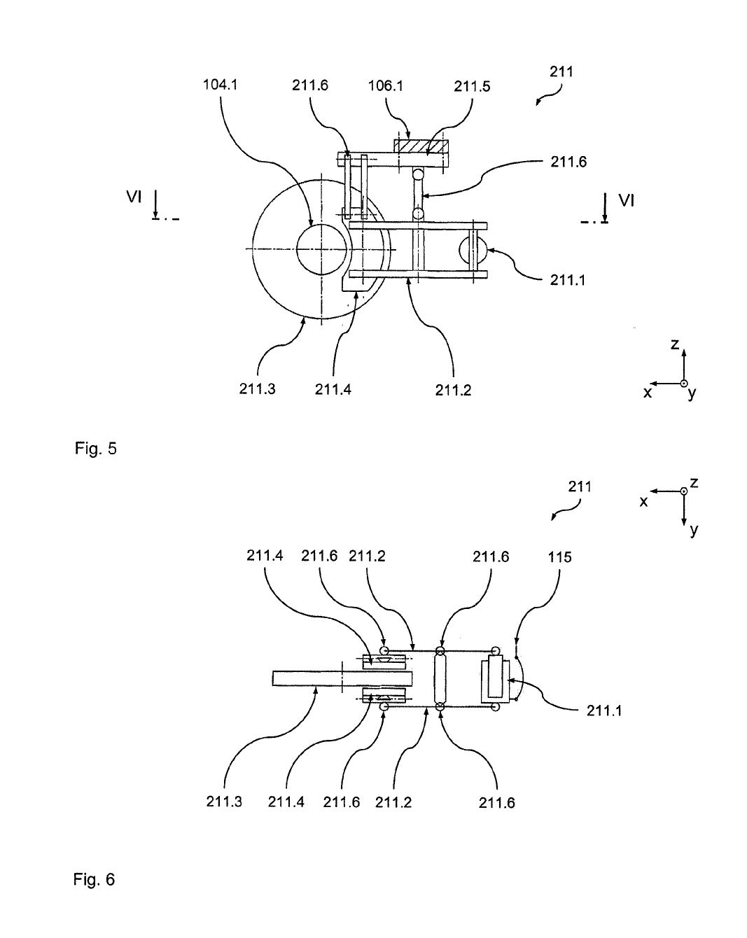

In the following, a further preferred embodiment of the braking system 209 according to the invention is described with reference to FIGS. 5 and 6, which can replace the braking system 109 in the vehicle 101. The braking system 209 in its structure and functionality basically corresponds to the braking system 109, such that only the differences shall be discussed here. Similar components are thus given reference numerals elevated by the value 100. Unless deviating statements are made in the following, reference is made to the above statements concerning the characteristics and functions of these components.

The only difference of the braking system 209 to the brake system 109 lies in the design of the braking apparatus 211, which is designed as a so-called suspended shackle brake in the present example. The latter has suspended shackles 211.6 articulated to an adaptor device 211.5 of the interface flange 106.1. The suspended shackles 211.6 in turn carry the calipers 211.2. The hydraulic brake actuator 211.1 connects both calipers 111.2 and, via their friction elements 211.4, generates the braking force acting on the brake disc 111.3.

It should be mentioned at this point that any other desired configuration of the hydraulic braking apparatus can be selected. For example, a configuration with a floating or fixed caliper brake design may be selected, which is connected directly on an axle bearing or gear housing of the respective wheelset 104. In other design variants, guiding of the brake calipers may ensue via bearings on the wheel set shaft in proximity to the brake discs, in which case a corresponding torque support or suspension, respectively, is provided at the bogie frame. An advantage of these versions, in addition to the savings (due to the hydraulic operation) in weight and required space already mentioned above, is the very precise guidance or positioning, respectively, of the calipers with respect to the brake disc.

The present invention in the foregoing has been described only by way of examples for rail vehicles. It is understood, however, that the invention may also be used in conjunction with any other vehicles.

1. A braking system for a rail vehicle comprising
a braking device, wherein
the braking device has a braking apparatus for braking at least one wheel of the rail vehicle and
the braking device has a pneumatic connection device for connection to a pneumatic energy supply unit for supplying the braking apparatus with pneumatic braking energy,
wherein
the braking apparatus is a hydraulic braking apparatus and wherein
the braking device has a converting device inserted between the pneumatic connection device and the braking apparatus for converting the pneumatic braking energy into hydraulic braking energy.

2. The braking system according to claim 1, wherein
the converting device comprises a converting unit,
the converting unit has a pneumatic input side, which is connectable to the pneumatic connecting device,
the converting unit has a hydraulic output side, which is connectable to the braking apparatus, and
the converting unit operates according to a principle of displacement with at least one piston-cylinder arrangement.

3. The braking system according to claim 1, wherein
the converting device is configured to convert an input pressure at the pneumatic input side to an output pressure at the hydraulic output side,
the output pressure is higher than the input pressure by 10 times to 200 times, the input pressure, and
the converting device comprises an input side piston-cylinder arrangement with an input side effective piston area and a mechanically coupled output side piston-cylinder arrangement with an output side effective piston area, wherein the input side effective piston area is 10 times to 200 times, the output side effective piston area.

4. The braking system according to claim 1, wherein
an adjusting device is provided, which is configured to reduce a working stroke of at least one braking element of the braking apparatus, wherein
the adjusting device is actuated by the converting device, wherein the converting device has a maximum working stroke and the actuation of the adjustment device only ensues when the working stroke of the converting device has reached 60% to 90% of the maximum working stroke;
the adjusting device comprises a piston-cylinder arrangement; and
the adjusting device is arranged in a common housing with the converting device.

5. The braking system according to claim 4, wherein
the adjusting device is configured to supply additional hydraulic fluid to a working chamber of the braking apparatus to reduce the working stroke of the at least one braking element,
the adjusting device is configured to supply, in a first step, during actuation of the braking apparatus, additional hydraulic medium to an intermediate storage, and to supply, in a second step following the first step, during a release of the braking apparatus, additional hydraulic medium from the intermediate storage to the working chamber; and
the intermediate storage is a spring-loaded storage, which autonomously supplies, in the second step, additional hydraulic medium to the working chamber.

6. The braking system according to claim 1, wherein
a slide protection device and/or a pneumatic pressure sensor is provided,
the slide protection device is configured to interrupt, under the control of a control device, a braking operation of the braking apparatus,
the pneumatic pressure sensor is configured to deliver a signal representative of a pneumatic braking pressure to a control device,
the slide protection device or the pneumatic pressure sensor is inserted between the pneumatic connection device and the converting device, the pneumatic pressure sensor being inserted between the slide protection device and the converting device;
the slide protection device comprises at least one venting valve controlled by the control device; and
the slide protection device or the pneumatic pressure sensor is arranged in a common housing with the converting device.

7. The braking system according to claim 1, wherein
at least one piston-cylinder assembly is provided, which defines a working chamber,
on the side of the piston facing away from the working chamber, a gas volume is defined, which is sealed from the environment,
the gas volume is connected to a respiration volume in such a way that a power loss created during use of the piston-cylinder arrangement due to the change of the gas volume is less than 2%;
the respiration volume is 2 l to 25 l; and
the respiration volume is arranged in a common housing with the converting device.

8. The braking system according to claim 1, wherein
the converting device comprises an emergency brake unit,
the emergency brake unit is connectable to a pneumatic emergency brake connection and,
the emergency brake unit is biased via the emergency brake connection with a pneumatic bias in such a manner that the emergency brake unit is actuated by the converting device upon a decrease of the pneumatic bias below a predeterminable value for initiating a braking operation, and
the emergency brake unit comprises a piston-cylinder assembly, which is biased by a mechanical, spring.

9. A running gear for a rail vehicle comprising
at least one wheel unit and
a braking system according to claim 1, wherein
the braking system is configured for braking at least one wheel unit of the running gear.

10. A rail vehicle comprising
at least one running gear with at least one wheel unit,
a wagon body supported on the at least one running gear, and
a braking system according to claim 1 and configured for braking the at least one wheel unit, of the running gear, wherein
the converting device is arranged at the wagon body in a region of the at least one running gear.

11. A method for actuating a braking device of a rail vehicle, comprising
supplying a braking device via a pneumatic energy supply unit with pneumatic brake energy for braking at least one wheel of the rail vehicle,
converting pneumatic braking energy into hydraulic braking energy via a converting device inserted between the pneumatic energy supply unit and a braking apparatus of the braking device, and
hydraulically operating the braking device.

12. The method according to claim 11, wherein
the converting device converts an input pressure at a pneumatic input side to an output pressure at a hydraulic output side, and
the output pressure is higher than the input pressure by 10 times to 200 times the input pressure.

13. The method according to claim 11, wherein
a working stroke of at least one braking element of the braking apparatus is reduced via an adjusting device, and
the adjusting device is actuated by the converting device, wherein the converting device has a maximum working stroke and the actuation of the adjustment device only ensues when the working stroke of the converting device has reached 60% to 90% of the maximum working stroke.

14. The method according to claim 13, wherein
the adjusting device supplies additional hydraulic fluid to a working chamber of the braking apparatus to reduce the working stroke of the at least one braking element,
the adjusting device supplies, in a first step during actuation of the braking apparatus, additional hydraulic medium to an intermediate storage, and supplies, in a second step following the first step during a release of the braking apparatus, additional hydraulic medium from the intermediate storage to the working chamber,
the intermediate storage autonomously supplies the additional hydraulic medium to the working chamber.

15. The method according to claim 11, wherein an emergency brake unit of the converting device is biased with a pneumatic bias in such a manner that the emergency brake unit actuates the converting device upon a decrease of the pneumatic bias below a predeterminable value for initiating a braking operation.
